(19) United States
(12) Patent Application Publication
(10) Pub. No.: US 2019/0286997 A1
(43) Pub. Date: Sep. 19, 2019

(54) FLOW-LINE CLASSIFYING DEVICE, FLOW-LINE CLASSIFYING METHOD, AND RECORDING MEDIUM

(71) Applicant: NEC CORPORATION, Tokyo (JP)

(72) Inventor: Akiko OSHIMA, Tokyo (JP)

(73) Assignee: NEC CORPORATION, Tokyo (JP)

(21) Appl. No.: 16/345,905

(22) PCT Filed: Oct. 23, 2017
(86) PCT No.: PCT/JP2017/038101

§ 371 Date: Apr. 29, 2019

(30) Foreign Application Priority Data
Oct. 31, 2016 (JP) 2016-213285

(51) Int. Cl. G06N 5/02; G06F 16/28; G06Q 10/06

(52) U.S. Cl. CPC G06N 5/02; G06Q 10/067; G06F 16/285

(57) ABSTRACT

A flow-line classifying device includes: a memory; and at least one processor coupled to the memory. The processor performs operations. The operations includes: acquiring, for a plurality of targets, flow-line information representing a path where the target has moved in a certain space and action information that is associated with the flow-line information and represents an action of the target at a position included in the path; classifying the acquired flow-line information, based on the action information associated with the flow-line information; and outputting the flow-line information classified.

### TECHNICAL FIELD

The present disclosure relates to a flow-line classifying device, a flow-line classifying method, and a recording medium.

### BACKGROUND ART

As one example of a human behavior analysis technique, there is a technique using a flow-line. PTL (Patent literature) 1, for example, discloses that a feature of a behavior of a person in a specific area in a store area is analyzed based on flow-line data acquired by tracking a path of the person having moved in the store area.

Further, PTL 2, for example, discloses that it is determined whether a person is a customer being an analysis target or not, based on a movement path, and thereby the analysis target is filtered.

### CITATION LIST

### Patent Literature

PTL 1: Japanese Unexamined Patent Application Publication No. 2009-48229

PTL 2: Japanese Unexamined Patent Application Publication No. 2014-232495

### SUMMARY OF INVENTION

### Technical Problem

However, as described in PTLs 1 and 2, there is a case in which it may be impossible to classify a person existing in a certain space, based only on how the person has moved in the space.

The present disclosure has been made in view of the issue described above, and an object thereof is to provide a technique of classifying flow-line information by using information different from the flow-line information.

### Solution to Problem

A flow-line classifying device according one aspect of the present disclosure includes:

acquisition means for acquiring, for a plurality of targets, flow-line information representing a path where the target has moved in a certain space and action information that is associated with the flow-line information and represents an action of the target at a position included in the path;

classifying means for classifying the acquired flow-line information, based on the action information associated with the flow-line information; and

outputting means for outputting the flow-line information classified by the classifying means.

A flow-line classifying method according to one aspect of the present discloser includes:

acquiring, for a plurality of targets, flow-line information representing a path where the target has moved in a certain space and action information that is associated with the flow-line information and represents an action of the target at a position included in the path;

classifying the acquired flow-line information, based on the action information associated with the flow-line information; and

outputting the classified flow-line information.

Note that, a computer program and a computer-readable non-transitory recording medium storing the computer program that achieve, by a computer, the devices or the method described above are also included in the scope of the present disclosure.

### Advantageous Effects of Invention

According to the present disclosure, flow-line information can be classified by using information different from the flow-line information.

### BRIEF DESCRIPTION OF DRAWINGS

FIG. 1 is a block diagram illustrating one example of a configuration of a flow-line classifying device according to a first example embodiment.

FIG. 2 is a flowchart illustrating one example of a flow of processing of the flow-line classifying device according to the first example embodiment.

FIG. 3 is a block diagram illustrating one example of a configuration of a flow-line display system according to a second example embodiment.

FIG. 4 is a function block diagram illustrating one example of a function configuration of a flow-line classifying device in the flow-line display system according to the second example embodiment.

FIG. 5 is a flowchart illustrating one example of a flow of pattern generation processing in the second example embodiment.

FIG. 6 is a flowchart illustrating one example of a flow of flow-line-information classification processing in the second example embodiment.

FIG. 7 is a diagram conceptually illustrating one example in which a certain store is overlooked from a ceiling.

FIG. 8 is a diagram illustrating one example in which a flow-line of a store clerk and a flow-line of a customer are displayed on a bird's-eye view of a certain store in an overlapping manner.

FIG. 9 is a diagram in which only the flow-line of the customer is displayed from the figure of FIG. 8.

FIG. 10 is a diagram illustrating one example of a pattern stored on a first storage unit.

FIG. 11 is a block diagram illustrating one example of a configuration of a flow-line display system according to a modified example.

FIG. 12 is a function block diagram illustrating one example of a function configuration of a flow-line classifying device in the flow-line display system according to the modified example.

FIG. 13 is a diagram illustrating one example of a data structure of flow-line information acquired by an acquisition unit and flow-line information.

FIG. 14 is a diagram illustrating another example of a data structure of flow-line information acquired by an acquisition unit and flow-line information.

FIG. 15 is a diagram exemplarily illustrating a hardware configuration of a computer (information processing device) capable of achieving each example embodiment.

### EXAMPLE EMBODIMENT

### First Example Embodiment

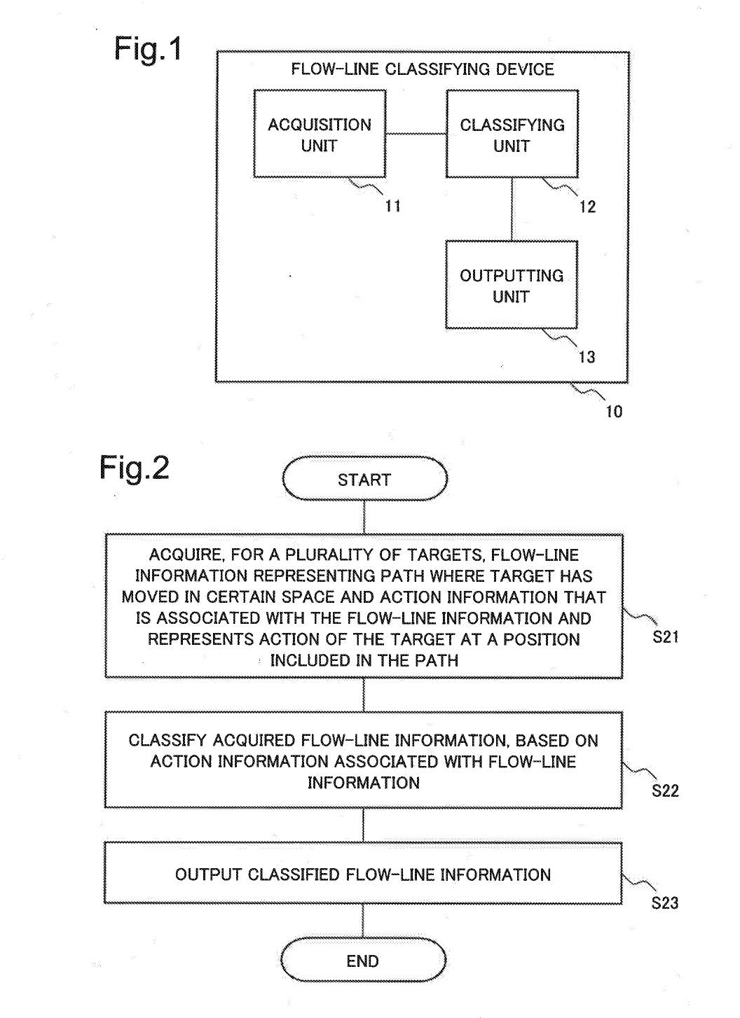

A first example embodiment of the present disclosure is described in detail with reference to the drawings. FIG. 1 is a block diagram illustrating one example of a configuration of a flow-line classifying device 10 according to the present example embodiment. As illustrated in FIG. 1, the flow-line classifying device 10 according to the present example embodiment includes an acquisition unit 11, a classifying unit 12, and an outputting unit 13.

The acquisition unit 11 acquires, for a plurality of targets, flow-line information representing a path where a target has moved in a certain space and action information that is associated with the flow-line information and represents an action of the target at a position included in the path. Herein, the certain space is a space where a plurality of targets move or stay and includes, for example, a store inside. Further, the target is, for example, a person.

Flow-line information represents time-series position information indicating positions of a target in different timings. Each position information is, for example, a coordinate in a certain space. Position information is associated with a time. Action information represents an action in a certain space such as bowing, cleaning, stacking shelves, bill collection, goods transportation and the like, and is associated with the position information. Action information may be data (e.g. a set of coordinate values) expressing a movement of a target acquired in a certain space. The action information may be information representing a type of an action. Information representing a type of an action may be a word representing a specific action specified by comparing data expressing an action of a target and a pattern for identifying a type of an action. It is assumed that, for example, a target is bowing. At that time, action information may be a set of coordinate values or a vector representing a movements of positions of constituent members (the head, an arm, a dynamic body, and the like) of a person to be a target, or may be a word representing an action of “bowing”.

The acquisition unit 11 supplies acquired flow-line information and acquired action information to the classifying unit 12.

The classifying unit 12 receives the flow-line information and action information which are acquired by the acquisition unit 11 from the acquisition unit 11. The classifying unit 12 classifies the received flow-line information, based on action information associated with the flow-line information.

When, for example, a certain space is a store, the classifying unit 12 classifies whether a person whose movement path is represented by acquired flow-line information is a store clerk or a customer, based on action information associated with the flow-line information. In the case of this example, the classifying unit 12 classifies flow-line information into a group representing a store clerk and a group representing a customer. Then, the classifying unit 12 supplies the flow-line information classified into each of a plurality of groups to the outputting unit 13. In the case of the example described above, the classifying unit 12 supplies the flow-line information classified into a group representing a store clerk and the flow-line information classified into a group representing a customer to the outputting unit 13 in association with information representing the classified groups.

The outputting unit 13 receives, from the classifying unit 12, the flow-line information classified into each of a plurality of groups by the classifying unit 12. Then, the outputting unit 13 outputs the classified flow-line information. The outputting unit 13 outputs, for example, from among a plurality of pieces of flow-line information acquired by the acquisition unit 11, the flow-line information classified into a group representing a customer by the classifying unit 12, for example, to a display device.

Next, with reference to FIG. 2, a flow of processing of the flow-line classifying device 10 of the present example embodiment is described. FIG. 2 is a flowchart illustrating one example of a flow of processing of the flow-line classifying device 10 according to the present example embodiment.

As illustrated in FIG. 2, first, the acquisition unit 11 of the flow-line classifying device 10 acquires, for a plurality of targets, flow-line information representing a path where a target has moved in a certain space and action information that is associated with the flow-line information and represents an action of the target at a position included in the path (step S21).

Then, the classifying unit 12 classifies the flow-line information acquired in step S21, based on the action information associated with the flow-line information (step S22).

Thereafter, the outputting unit 13 outputs the flow-line information classified in step S22 (step S23).

As described above, the flow-line classifying device 10 terminates the processing.

As described above, the flow-line classifying device 10 according to the present example embodiment classifies flow-line information by using action information associated with the flow-line information. Action information represents an action of a target in a certain space. For example, in the case of a store, a store clerk frequently performs a predetermined action. Therefore, the flow-line classifying device 10 classifies, by using action information representing such an action, action information associated with the action information. In this manner, according to the present example embodiment, flow-line information representing a path where a target has moved can be classified by using information different from the flow-line information. Therefore, the flow-line classifying device 10 is able to display flow-line information included in a classified group, for example, on a display device. Therefore, a user can easily grasp only flow-line information of a target included in a target group. Further, by using flow-line information accurately classified, for example, accuracy of analysis such as marketing can also be enhanced.

### Second Example Embodiment

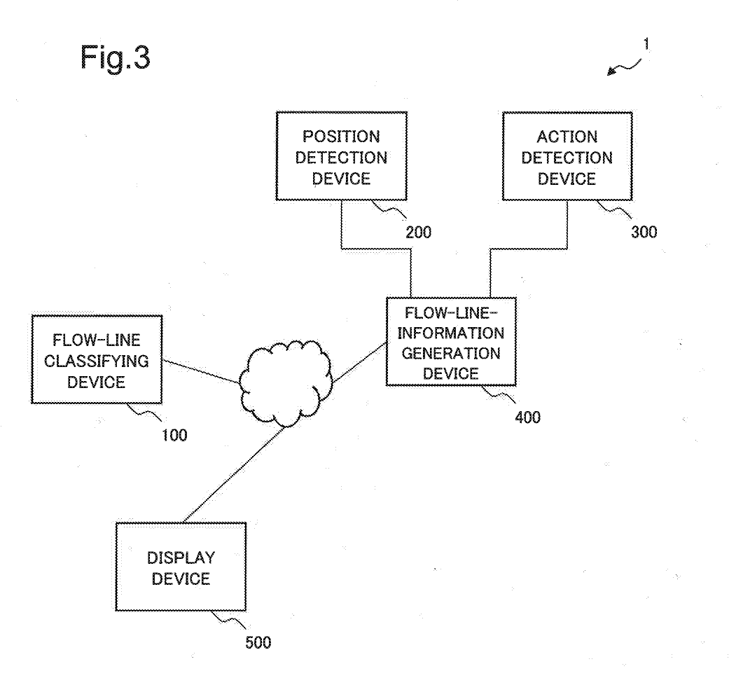

Next, a second example embodiment of the present disclosure based on the first example embodiment described above is described with reference to the drawings. FIG. 3 is a diagram illustrating one example of a configuration of a flow-line display system 1 according to the present example embodiment. As illustrated in FIG. 3, the flow-line display system 1 includes a flow-line classifying device 100, a position detection device 200, an action detection device 300, a flow-line-information generation device 400, and a display device 500. The flow-line classifying device 100, the flow-line-information generation device 400, and the display device 500 are communicably connected to one another. Further, the flow-line-information generation device 400 is communicably connected to the position detection device 200 and the action detection device 300. Note that the position detection device 200, the action detection device 300, the flow-line-information generation device 400, and the display device 500 may be built in the flow-line classifying device 100 respectively. A plurality of position detection devices 200 and a plurality of action detection devices 300 are applicable.

The position detection device 200 acquires data capable of generating flow-line information representing a movement path of a target in a certain space. In the present example embodiment, description is made, assuming that a target is a person. The position detection device 200 is achieved by using an image capture device such as a surveillance camera and the like. In this case, the position detection device 200 supplies moving image data acquired by capturing a person to the flow-line-information generation device 400. Note that the position detection device 200 needs only to be a device that acquires data capable of detecting a position of a person in a certain space such as a store, and may be, for example, a floor pressure sensor, a sensor using radio waves of a global positioning system (GPS), or the like.

The action detection device 300 acquires data capable of generating action information. Description is made, assuming that action information is data (e.g. a set of coordinate values) expressing a movement of a target acquired in a certain space. The action detection device 300 is achieved by using, for example, a three-dimensional camera of a time-of-flight (TOF) system. In this case, the action detection device 300 supplies captured three-dimensional data to the flow-line-information generation device 400. Note that the action detection device 300 needs only to be a device that detects, at a position of a person detected by the position detection device 200 in a certain space such as a store, a three-dimensional action of the person, and acquires data capable of generating action information representing the detected action. When, for example, a person has bowed, the action detection device 300 may detect that an action has been performed and further acquire moving image data to be a basis of action information related to a set of coordinate values or a vector representing movements of positions of constituent members (the head, an arm, a dynamic body, and the like) of a person to be a target.

The flow-line-information generation device 400 generates flow-line information by using data acquired from the position detection device 200. Specifically, when data acquired from the position detection device 200 are moving image data, the flow-line-information generation device 400 generates flow-line information by analyzing the moving image data and specifying a position and a moving direction of a moving person at each time. Further, the flow-line-information generation device 400 generates action information by using data acquired from the action detection device 300. The flow-line-information generation device 400 confirms whether a position where an action represented by action information has been performed is included in a path represented by flow-line information or not, and associates, when the position is included, the flow-line information with the action information. The flow-line-information generation device 400 may transmit the flow-line information associated with the action information to the flow-line classifying device 100.

The display device 500 displays a screen, based on control from the flow-line classifying device 100. The display device 500 is achieved by using, for example, a liquid crystal display and the like. Further, the display device 500 may be configured to receive, from the flow-line classifying device 100, a result of classification executed by the flow-line classifying device 100 and display a screen, based on the classification result. A screen displayed by the display device 500 is described later by changing the drawing.

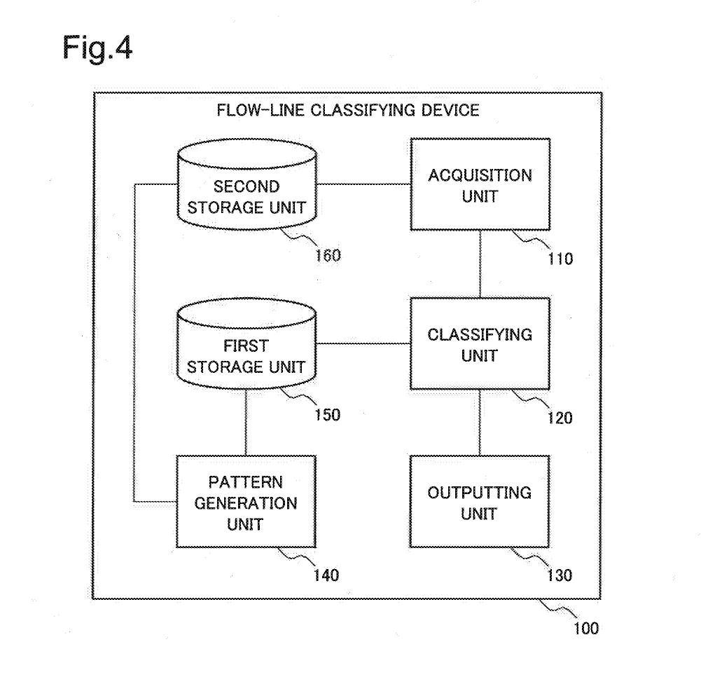

Next, a configuration of the flow-line classifying device 100 will be described with reference to FIG. 4. FIG. 4 is a function block diagram illustrating one example of a function configuration of the flow-line classifying device 100 of the flow-line display system 1 according to the present example embodiment. As illustrated in FIG. 4, the flow-line classifying device 100 according to the present example embodiment includes an acquisition unit 110, a classifying unit 120, and an outputting unit 130. The flow-line classifying device 100 may further include a pattern generation unit 140, a first storage unit 150, and a second storage unit 160. Note that, in the present example embodiment, a configuration in which the first storage unit 150 and the second storage unit 160 are included in the flow-line classifying device 100 is described, but the first storage unit 150 and the second storage unit 160 may be achieved by a device separate from the flow-line classifying device 100. Further, the first storage unit 150 and the second storage unit 160 may be separate storage units or may be achieved by the similar storage unit.

The acquisition unit 110 is one example of the acquisition unit 11 in the first example embodiment described above. The acquisition unit 110 acquires, for a plurality of persons, flow-line information representing a path where a person has moved in a certain space and action information that is associated with the flow-line information and represents an action of the person at a position included in the path. Flow-line information and action information are input from the flow-line-information generation device 400 to the flow-line classifying device 100, and they are stored in the second storage unit 160. In this case, the acquisition unit 110 acquires flow-line information and action information stored in the second storage unit 160 from the second storage unit 160.

Note that the second storage unit 160 may store learning data previously registered on the flow-line classifying device 100, from among learning data used by the pattern generation unit 140 to be described later generating a pattern. The learning data are described later.

Further, in the configuration where flow-line information associated with action information is transmitted from the flow-line-information generation device 400, by the acquisition unit 110 receiving the flow-line information, the acquisition unit 110 may acquire flow-line information and action information associated with the flow-line information. Further, when the flow-line-information generation device 400 is built in the flow-line classifying device 100, by executing the function of the flow-line-information generation device 400 described above, the acquisition unit 110 may acquire flow-line information associated with action information. In this manner, a method in which the acquisition unit 110 acquires flow-line information is not specifically limited. Note that an example in which the function of the flow-line-information generation device 400 is built in the flow-line classifying device 100 is described in a modified example.

The acquisition unit 110 supplies acquired flow-line information to the classifying unit 120.

The first storage unit 150 stores a pattern used when the classifying unit 120 classifies flow-line information. This pattern is a pattern indicating that, for example, a person for whom flow-line information has been acquired is a person (e.g. a customer or a store clerk) included in a predetermined group.

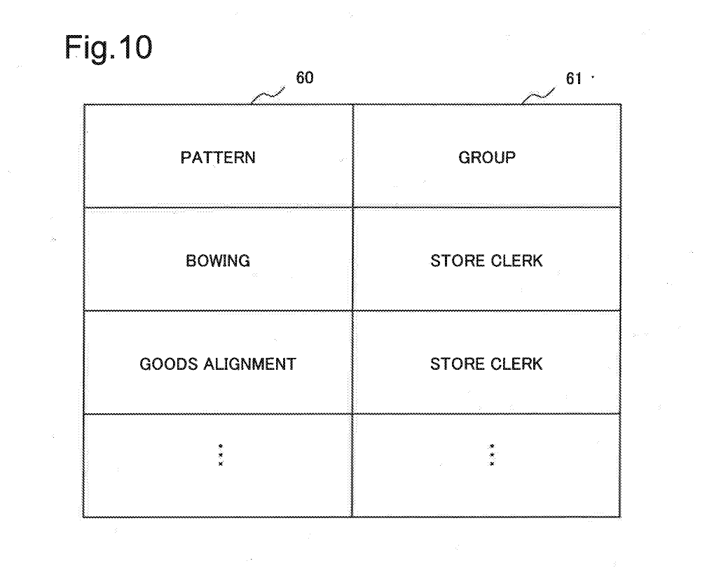

With reference to FIG. 10, a pattern stored in the first storage unit 150 is further described. As illustrated in FIG. 10, a pattern 60 stored in the first storage unit 150 is data expressing a specific action such as “bowing” or “goods alignment”. Data expressing a specific action is, in the case of “bowing”, for example, a set of coordinate values, a vector, or the like which represents movements of positions of constituent members (the head, an arm, a dynamic body, and the like) of a person. Note that the pattern 60 stored in the first storage unit 150 is not limited to “bowing” and “goods alignment”, but also may be, for example, data expressing an action such as goods arrangement in a store (stacking shelves), cleaning, bill collection, replacement of consumables or the like, goods transportation. Further, the first storage unit 150 may store the pattern 60 associated with each of a plurality of groups. The first storage unit 150 may store, as the pattern 60, for example, data expressing an action of a customer associated with a “customer” group.

Further, the pattern 60 may be information representing a type of an action. A word (e.g. bowing) representing a specific action is applicable. Further, the pattern 60 may include both data expressing a specific action and information representing a type of an action. Thereby, action information is specified what type of action by being compared with the pattern 60.

The pattern 60 is associated with a group 61. As illustrated in FIG. 10, “bowing” and “goods alignment” are associated with a “store clerk” group. Thereby, action information is specified what type of action by being compared with a pattern.

Further, the pattern 60 may be associated with information representing a space. In other words, the pattern 60 may be different according to a space. When, for example, a pattern 60 of “bowing” is stored, information indicating a clothing store may be associated with the pattern.

The classifying unit 120 is one example of the classifying unit 12 in the first example embodiment described above. The classifying unit 120 receives flow-line information from the acquisition unit 110. The classifying unit 120 classifies the received flow-line information, based on action information associated with the flow-line information. At that time, the classifying unit 120 compares action information with a predetermined pattern stored in the first storage unit 150 and thereby classifies flow-line information associated with the action information. When, for example, action information associated with received flow-line information is matched with a pattern of “bowing” illustrated in FIG. 10, the classifying unit 120 classifies the flow-line information associated with the action information into a “store clerk” group associated with the pattern of “bowing”. Note that, in the present example embodiment, a “pattern matched with action information” does not indicate a pattern completely matched with action information. In the present example embodiment, a pattern most similar to action information (data expressing an action) is referred to as a pattern matched with action information. Note that a method of comparing action information with a patter may be any method, and an existing technique is employable.

Note that the classifying unit 120 may classify action information by using a pattern different according to a space. When, for example, a space being a target, for which the position detection device 200 and the action detection device 300 respectively detect a position and an action, is a convenience store, by comparing a pattern related to a convenience store with action information, flow-line information may be classified. Further, when, for example, a space being a target, for which the position detection device 200 and the action detection device 300 respectively detect a position and an action, is a clothing store, by comparing a pattern related to a clothing store with action information, flow-line information may be classified.

Then, the classifying unit 120 supplies flow-line information classified into each of a plurality of groups to the outputting unit 130.

Note that, when using action information associated with flow-line information classified into a predetermined group as learning data to be described later, the classifying unit 120 may associate information representing a classified group with flow-line information stored in the second storage unit 160. At that time, the classifying unit 120 may associate information (e.g. a word such as “bowing” and the like) representing a type of an action represented by action information associated with flow-line information. Thereby, the second storage unit 160 stores flow-line information associated with information representing a classified group. Note that, in the present example embodiment, when using flow-line information stored on the second storage unit 160 as learning data, description is made assuming that the flow-line information is associated with information representing a classified group and information representing a type of an action.

The outputting unit 130 is one example of the outputting unit 13 in the first example embodiment described above. The outputting unit 130 outputs flow-line information classified into a specific group by the classifying unit 120. The outputting unit 130 may output, to the display device 500, for example, a signal for displaying, on the display device 500, a screen in which a bird's-eye view representing a layout of a store is overlapped with flow-line information. Note that an outputting method of the outputting unit 130 is not limited thereto, and outputting may be executed, for example, through printing on paper.

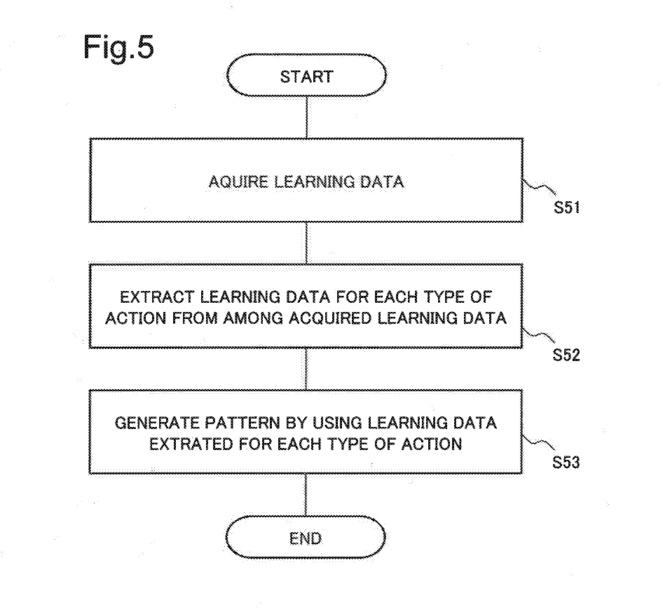

The pattern generation unit 140 generates a pattern to be stored on the first storage unit 150. The pattern generation unit 140 stores the generated pattern in the first storage unit 150. Pattern generation processing executed by the pattern generation unit 140 is further described with reference to FIG. 5.

FIG. 5 is a flowchart illustrating one example of a flow of pattern generation processing in the present example embodiment.

As illustrated in FIG. 5, the pattern generation unit 140 acquires learning data for each specific group from the second storage unit 160 (step S51). When learning data are data previously registered on the flow-line classifying device 100, the learning data are data expressing an action in which information representing a group and information representing a type of an action are associated with each other. Further, as described above, learning data may be action information associated with flow-line information classified by the classifying unit 120. The pattern generation unit 140 acquires, as learning data, data expressing an action and/or action information associated with information representing a specific group. The pattern generation unit 140 acquires, for example, action information of a store clerk included in a store clerk group as learning data.

Then, the pattern generation unit 140 extracts learning data for each type of an action among the acquired learning data (step S52). The pattern generation unit 140 extracts, for example, learning data associated with information representing a type of an action of “bowing” among the learning data acquired in step S51. Note that, when information representing a space is further associated with the acquired data, the pattern generation unit 140 may extract learning data for each of the spaces.

Thereafter, the pattern generation unit 140 generates a pattern by using learning data extracted for each type of an action (step S53). The pattern generated by the pattern generation unit 140 is stored in the first storage unit 150, and thereby the classifying unit 120 is able to classify flow-line information by using the pattern.

Further, the pattern generation unit 140 may set, for example, data previously registered by a user as a pattern. When, for example, a user registers data expressing an action of a store clerk on the flow-line classifying device 100, the pattern generation unit 140 sets, as a pattern of a store clerk, data expressing the registered action. In this manner, a method in which the pattern generation unit 140 generates a pattern is not specifically limited.

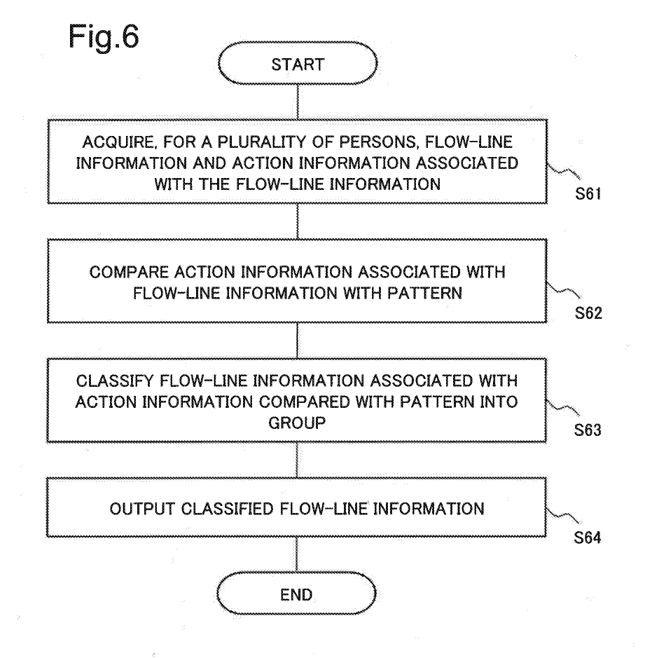

Next, with reference to FIG. 6, a flow of flow-line-information classification processing in the flow-line classifying device 100 according to the present example embodiment is described. FIG. 6 is a flowchart illustrating one example of a flow of flow-line-information classification processing in the flow-line classifying device 100 according to the present example embodiment.

As illustrated in FIG. 6, first, the acquisition unit 110 acquires, for a plurality of persons, flow-line information representing a path where a person has moved in a certain space, and action information that is associated with the flow-line information and represents an action of the person at a position included in the path (step S61).

Then, the classifying unit 120 compares the action information associated with the flow-line information acquired in step S61 with a pattern stored on the first storage unit 150 (step S62). Then, the classifying unit 120 classifies flow-line information associated with the action information compared with the pattern into a group (step S63).

Thereafter, the outputting unit 130 outputs the classified flow-line information (step S64).

As described above, the flow-line classifying device 100 terminates flow-line-information classification processing.

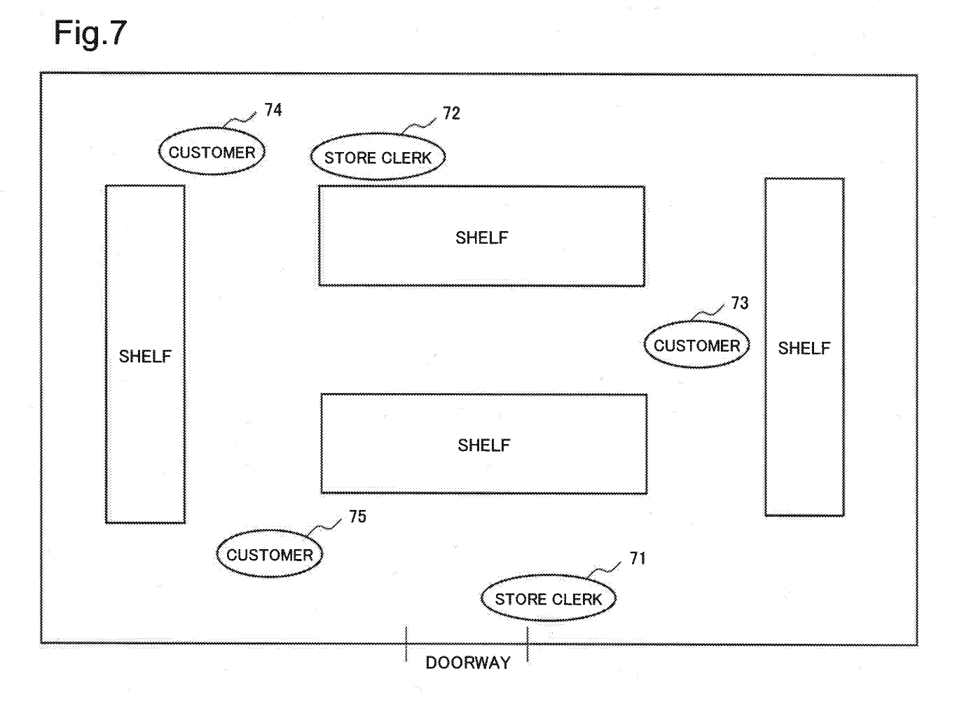

FIG. 7 is a diagram conceptually illustrating one example in which a certain store is overlooked from a ceiling. It is assumed that, in the store illustrated in FIG. 7, there are store clerks 71 and 72, and customers 73, 74, and 75.

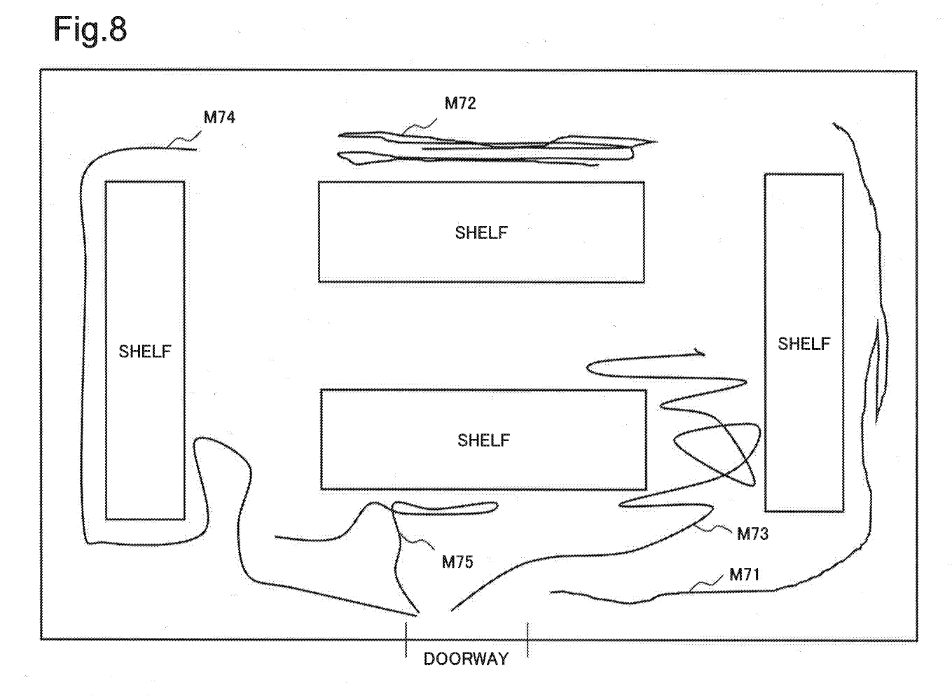

FIG. 8 is a diagram illustrating one example in which flow-lines of store clerks and flow-lines of customers are displayed on a bird's-eye view of a store illustrated in FIG. 7 in an overlapping manner. In the figure of FIG. 8, description of the store clerks 71 and 72, and the customers 73, 74, and 75 illustrated in FIG. 7 is omitted.

In FIG. 8, a flow-line of the store clerk 71 is indicated as a flow-line M71 and a flow-line of the store clerk 72 is indicated as a flow-line M72. Further, in FIG. 8, a flow-line of the customer 73 is indicated as a flow-line M73, a flow-line of the customer 74 is indicated as a flow-line M74, and a flow-line of the customer 75 is indicated as a flow-line M75.

The classifying unit 120 classifies flow-line information representing each of such flow-lines M71 to M75, based on action information associated with the flow-line information. It is assumed that, for example, flow-line information representing the flow-line M71 of the store clerk 71 is associated with action information indicating an action of “bowing”. Further, it is assumed that flow-line information representing the flow-line M72 of the store clerk 72 is associated with action information indicating an action of “goods alignment”. The classifying unit 120 compares a pattern stored in the classifying unit 120 with action information, and classifies flow-line information associated with the action information into a group associated with a pattern related to the action information. Patterns representing “bowing” and “goods alignment” are associated with a store clerk group, for example, as illustrated in FIG. 10. Therefore, the classifying unit 120 classifies flow-line information representing the flow-line M71 and flow-line information representing the flow-line M72 into a store clerk group. Further, the classifying unit 120 may classify flow-line information that is not classified into a store clerk group into a customer group or another group. In the present example embodiment, the classifying unit 120 classifies flow-line information that is not classified into a store clerk group into a customer group. In other words, the classifying unit 120 classifies flow-line information representing the flow-line M73, flow-line information representing the flow-line M74, and flow-line information representing the flow-line M75 into a customer group. Note that, when a pattern associated with a customer is stored in the first storage unit 150, the classifying unit 120 may classify flow-line information associated with action information related to the pattern of the customer into a customer group.

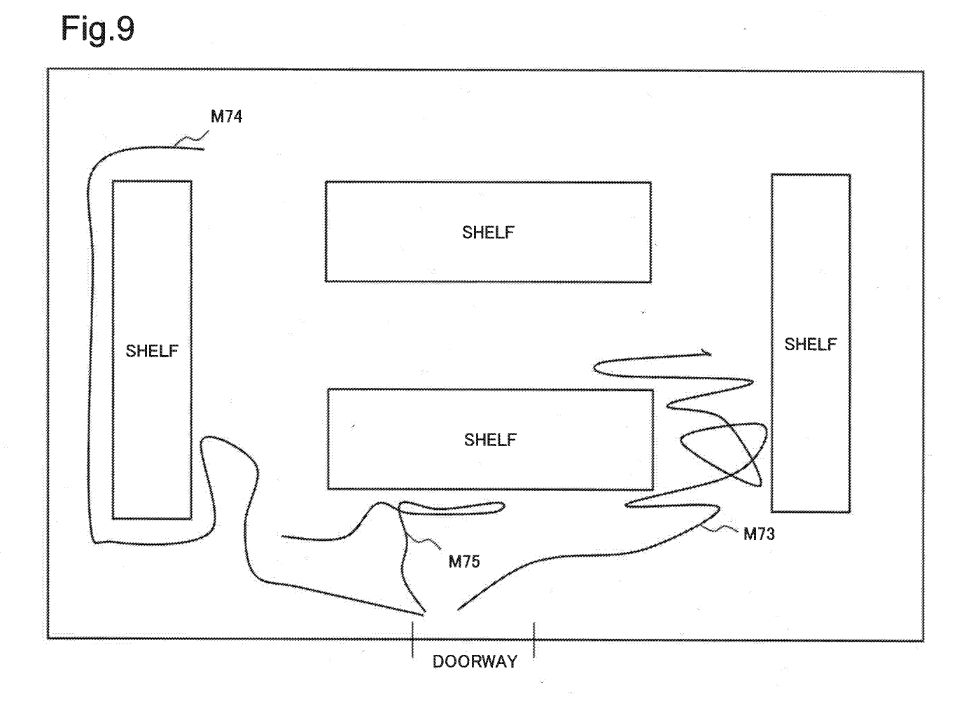

Thereafter, the outputting unit 130 outputs flow-line information classified into a specific group, for example, to the display device 500. One example in which the outputting unit 130 causes the flow-line-information generation device 400 to display a flow-line represented by flow-line information classified into a customer group by the classifying unit 120 is illustrated in FIG. 9. In comparison with FIG. 8, in FIG. 9, the flow-lines M73 to M75 are displayed and the flow-lines M71 and M72 are not displayed. In this manner, the outputting unit 130 causes the display device 500 to display only flow-line information classified into a specific group (in this case, a customer group).

In this manner, the flow-line classifying device 100 according to the present example embodiment classifies flow-line information by using action information associated with the flow-line information. In this manner, according to the present example embodiment, it is possible to classify flow-line information representing a path where a person has moved by using information different from the flow-line information. Therefore, the flow-line classifying device 100 is able to cause the display device 500 to display flow-line information included in a classified group, for example. Therefore, it is possible to make a user (e.g. an operator of the display device 500) easily grasp only flow-line information of a specific group. Further, it is possible to enhance accuracy of analysis such as marketing by using flow-line information accurately classified into a specific group.

Further, in the present example embodiment, the classifying unit 120 classifies flow-line information by comparing a predetermined pattern stored in the first storage unit 150 with action information. Thereby, the flow-line classifying device 100 is able to accurately classify flow-line information of a person who performs an action of a predetermined pattern into a group that performs the action of the predetermined pattern.

Further, in the present example embodiment, the classifying unit 120 classifies flow-line information by using a pattern different according to a space. For example, when types of spaces are different as in a convenience store and a clothing store, actions performed by store clerks may be different from each other. For example, in a clothing store, action information of a store clerk includes an action of performing clothes alignment, but in a convenience store, action information of a store clerk does not include an action of performing clothes alignment. Therefore, the classifying unit 120 classifies by using a pattern of a related space, depending on which space the flow-line information to be classified is acquired, and thereby the flow-line classifying device 100 is able to more accurately classify flow-line information.

Note that a method in which the classifying unit 120 classifies flow-line information is not limited to the method described above. The classifying unit 120 may classify, based on the number of times of an action of a predetermined pattern included in flow-line information, flow-line information associated with the action information. It is assumed that, for example, a pattern of an action of a store clerk stored in the first storage unit 150 is data expressing “bowing”. Then, it is assumed that the pattern is associated with information representing a condition for the number of times of the action (e.g. three times or more). When comparing action information with a pattern and determining that the action information is matched with a pattern in which patterns of “bowing” (data expressing “bowing”) are repeated a plurality of times, the classifying unit 120 specifies the repeated number of times. When the number of times of an action of “bowing” included in action information matched with a pattern of “bowing” is “four times”, the number of times of the action satisfies “three times or more” associated with a pattern of “bowing”, and therefore the classifying unit 120 classifies flow-line information associated with the action information into a store clerk group. Alternatively, when, for example, the number of times of an action of “bowing” included in action information matched with a pattern of “bowing” is “once”, the classifying unit 120 classifies flow-line information associated with the action information into a customer group. In this manner, even when there is a possibility that a customer and a store clerk perform the similar action, by classifying based on the number of times of an action performed repeatedly by a certain group (e.g. a store clerk) compared to compared with another group (e.g. a customer), the flow-line classifying device 100 is able to accurately classify flow-line information.

Further, the classifying unit 120 may, by comparing a combination of information of a path included in flow-line information and action information associated with the flow-line information with a predetermined pattern, classify the flow-line information. At that time, a pattern stored in the pattern generation unit 140 is a combination of data expressing an action and information representing a path. It is assumed that, for example, in a certain store, an action performed by a store clerk includes moving from a checkout counter to a doorway, and bowing in a vicinity of the doorway. In this case, the pattern generation unit 140 stores a pattern combining information representing a path from the checkout counter to the doorway and data expressing an action of bowing in the vicinity of the doorway. The classifying unit 120 compares this pattern with a combination of information of a path included in flow-line information and action information associated with the flow-line information. In this manner, because the classifying unit 120 classifies flow-line information, by also using a path included in flow-line information associated with action information, the flow-line classifying device 100 is able to more accurately classify flow-line information.

Further, the classifying unit 120 may, by comparing a combination of a position included in flow-line information and action information associated with the flow-line information with a predetermined pattern, classify the flow-line information. At that time, a pattern stored in the pattern generation unit 140 is a combination of data expressing an action and information representing a position at which the action is performed. It is assumed that, for example, in a certain store, an action performed by a store clerk is bowing in a vicinity of a doorway. In this case, the pattern generation unit 140 stores a pattern combined with data expressing an action of bowing in the vicinity of the doorway. The classifying unit 120 compares this pattern with a combination of information of a position included in flow-line information and action information associated with the flow-line information. In this manner, because the classifying unit 120 classifies flow-line information, by also using a position included in flow-line information associated with action information, the flow-line classifying device 100 is able to more accurately classify flow-line information.

Note that the position detection device 200 and the action detection device 300 may be achieved by using the same image capture device. At that time, the flow-line-information generation device 400 generates, by using moving image data acquired from the image capture device, flow-line information and action information, and associates the generated action information with flow-line information. Then, the flow-line-information generation device 400 may input the flow-line information associated with the action information to the flow-line classifying device 100.

Further, the flow-line-information generation device 400 may generate information representing a type of an action as action information. At that time, a pattern stored in the first storage unit 150 and information representing a type of an action are associated, and, then, are stored in the flow-line-information generation device 400. When a pattern is data expressing “bowing”, the pattern is associated with “bowing” as information representing a type of an action. Then, the flow-line-information generation device 400 executes comparison with a pattern by using data acquired from the action detection device 300, and generates, as action information, information representing a type of an action associated with a pattern matched with the acquired data. When a pattern matched with data acquired from the action detection device 300 is, for example, a pattern of “bowing”, the flow-line-information generation device 400 generates, as action information, “bowing” that is information representing a type of an action associated with the pattern of “bowing”. Then, the flow-line-information generation device 400 outputs the flow-line information associated with “bowing” to the flow-line classifying device 100. The first storage unit 150 of the flow-line classifying device 100 stores, as a pattern, information (e.g. a word of “bowing”) representing a type of an action. Therefore, thereby, the classifying unit 120 determines that “bowing” associated with flow-line information and “bowing” stored as a pattern are matched with each other, and classifies the flow-line information into a group associated with “bowing” stored as a pattern.

Further, the flow-line-information generation device 400 may specify a type of an action (e.g. “bowing”) by using data acquired from the action detection device 300. A method in which the flow-line-information generation device 400 specifies a type of an action is not specifically limited, and may be adapted an existing technique. Then, the flow-line-information generation device 400 may output, as action information, a specified type of an action. In this case, the first storage unit 150 of the flow-line classifying device 100 stores information representing a type of an action as a pattern. Therefore, the classifying unit 120 is able to classify flow-line information associated with the action information by comparing the pattern with action information.

### Modified Example

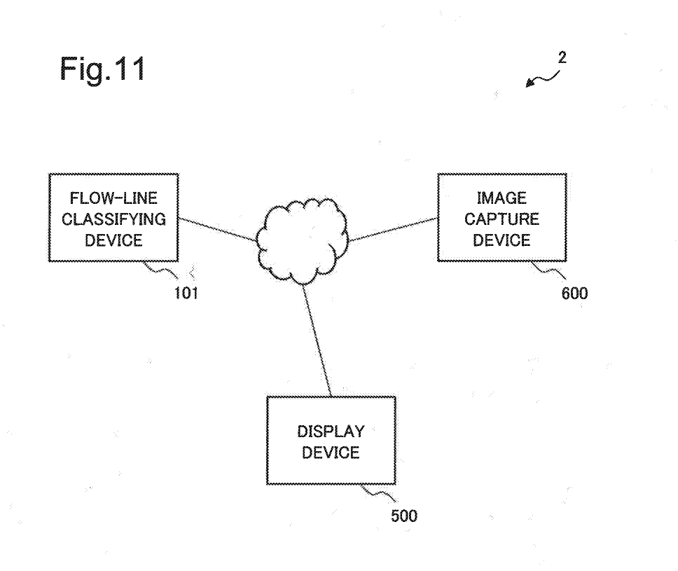

Further, the flow-line classifying device 100 may include a function of the flow-line-information generation device 400. An example of this case is described with reference to the drawings. FIG. 11 is a diagram illustrating one example of a configuration of a flow-line display system 2 according to the present modified example. The flow-line display system 2 includes an image capture device 600, a flow-line classifying device 101, and the display device 500. The image capture device 600 is a device in which the position detection device 200 and the action detection device 300 described above are integrated. The image capture device 600 transmits a captured video (referred to also as moving image data) to the flow-line classifying device 101.

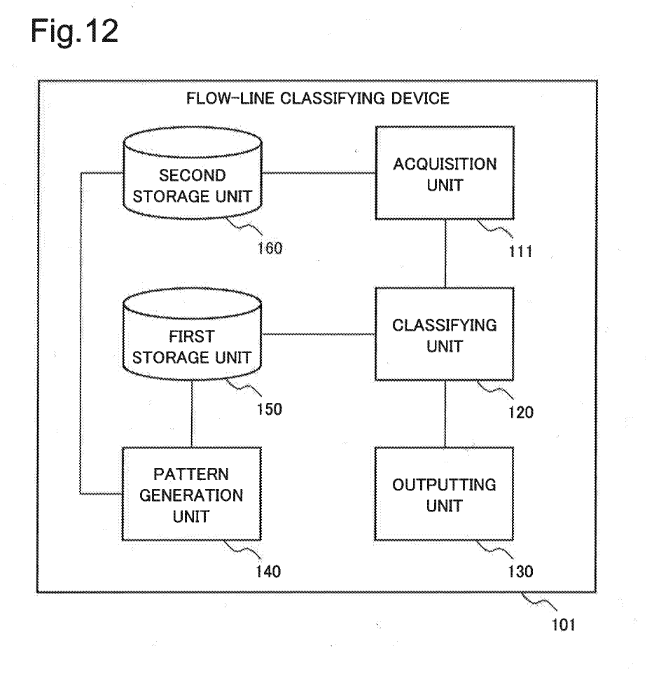

FIG. 12 is a function block diagram illustrating one example of a function configuration of the flow-line classifying device 101. As illustrated in FIG. 12, the flow-line classifying device 101 includes an acquisition unit 111, the classifying unit 120, the outputting unit 130, the pattern generation unit 140, the first storage unit 150, and the second storage unit 160. The flow-line classifying device 101 includes the acquisition unit 111, instead of the acquisition unit 110 of the flow-line classifying device 100.

The acquisition unit 111 acquires flow-line information and action information associated with the flow-line information from a video acquired by the image capture device 600. The acquisition unit 111 receives moving image data output from the image capture device 600. Then, the acquisition unit 111 analyzes the moving image data and specifies a movement position and a direction of a person moving at each time, and therefore generates flow-line information. Further, the acquisition unit 111 analyzes the moving image data and detects a start and an end of an action of a target in a position on a path, and therefore generates action information that is information of an action of the target at the position. Note that a method of generating flow-line information from moving image data and a method of detecting an action of a target from moving image data and generating action information are not specifically limited, and may be adapted an existing technique. The acquisition unit 111 according to the present modified example generates flow-line information and action information from moving image data in this manner, and thereby acquires the flow-line information and the action information.

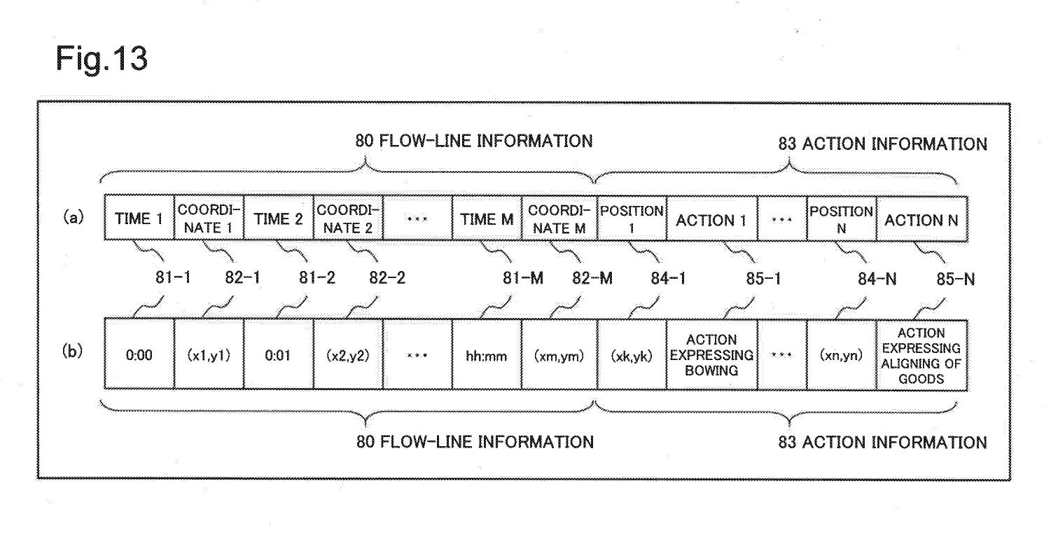

FIG. 13 illustrates one example of a data structure of flow-line information associated with action information acquired (generated) and flow-line information which are acquired by the acquisition unit 111 at that time. Part (a) of FIG. 13 illustrates one example of a data structure of flow-line information and action information, and part (b) of FIG. 13 illustrates a specific example of flow-line information and action information.

As illustrated in FIG. 13, flow-line information 80 and action information 83 are associated with each other. The flow-line information 80 includes time data (81-1 to 81-M (M is any natural number)) and coordinate data (82-1 to 82-M). Further, the action information 83 includes position data (84-1 to 84-N(N is any natural number)) on a path and action data (85-1 to 85-N).

The time data (81-1 to 81-M) and the coordinate data (82-1 to 82-M) respectively represent a time at which a position of a target has been recorded and a position of the target at the time. The time data (81-1 to 81-M) and the coordinate data (82-1 to 82-M) may be recorded at a predetermined interval or may be acquired at any timing. The time data 81-1 and the coordinate data 82-1 are associated with each other. Similarly, the time data 81-M and the coordinate data 82-M are associated with each other. A line connecting the coordinate data (82-1 to 82-M) represents a flow-line.

The time data (81-1 to 81-M) may be in a format of hh:mm as illustrated in part (b) of FIG. 13, or may be in another format. Further, the coordinate data (82-1 to 82-M) may be in a format of (xm,ym) as illustrated in (b) of FIG. 13, or may be in another format.

The position data (84-1 to 84-N) included in the action information 83 indicates a position at which an action has been performed by a target, the position being a position of the coordinate data (82-1 to 82-M). The action data (85-1 to 85-N) is data expressing an action of a target at a position indicated by position data, and is expressed, for example, by a set of coordinate values or a set of vectors. The position data 84-1 and the action data 85-1 are associated with each other. Similarly, the position data 84-N and the action data 85-N are associated with each other. The position data (84-1 to 84-N) is in a format similar to a format for coordinate data as illustrated in (b) of FIG. 13, but may be in another format. Further, the action data (85-1 to 85-N) is, for example, a set of coordinate values as data of an action expressing “bowing”, a set of coordinate values as data of an action expressing “goods alignment”, or the like.

Thereby, the classifying unit 120 in the present modified example is able to compare, similarly to the classifying unit 120 in the second example embodiment, a pattern being data stored in the first storage unit 150 and expressing a specific action with action information, and therefore classify flow-line information associated with the action information.

Further, similarly to the second example embodiment, the acquisition unit 111 may generate, as action information, information representing a type of an action. At that time, the acquisition unit 111 analyzes moving image data acquired by the image capture device 600, detects an action of a target at a position on a path, and specifies a type of the action. The acquisition unit 111 analyzes moving image data, and specifies whether an action of a target included in the moving image data is any action of, for example, bowing, goods alignment, e.g. goods arrangement in a store (stacking shelves), cleaning, bill collection, replacement of consumables or the like, goods transportation, and the like. The specifying method is not specifically limited, and may be adapted existing technique. Further, the acquisition unit 111 may execute comparison with, for example, data expressing a specific action stored in the first storage unit 150, and therefore specify a type of an action of a target included in moving image data.

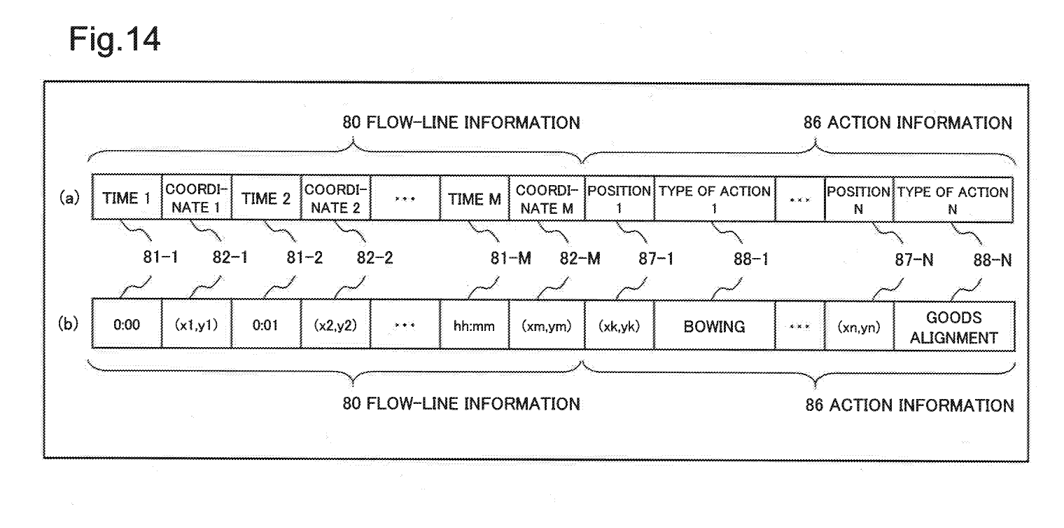

At that time, FIG. 14 illustrates another example of a data structure of flow-line information associated with action information and flow-line information which are acquired (generated) by the acquisition unit 111. Part (a) of FIG. 14 illustrates another example of a data structure of flow-line information and action information, and part (b) of FIG. 14 illustrates a specific example of flow-line information and action information.

Flow-line information 80 illustrated in FIG. 14 is similar to the flow-line information 80 illustrated in FIG. 13. The flow-line information 80 and action information 86 are associated with each other. The action information 86 includes position data (87-1 to 87-N) on a path and data (88-1 to 88-N) of a type of an action.

The position data (87-1 to 87-N) included in the action information 86 is similar to the position data (84-1 to 84-N) described above. The data (88-1 to 88-N) of a type of an action is data indicating a type of an action of a target at a position indicated by position data and are, for example, a word representing an action of “bowing”. The position data 87-1 and the data 88-1 of a type of an action are associated with each other. Similarly, the position data 87-N and the data 88-N of a type of an action are associated with each other.

Thereby, the classifying unit 120 in the present modified example is able to compare a pattern, which is stored in the first storage unit 150 and is information representing a type of an action, with action information, and therefore classify flow-line information associated with the action information.

As described above, even the flow-line classifying device 101 included in the flow-line display system 2 according to the present modified example is able to achieve an advantageous effect similar to that of the flow-line classifying device 100 described above.

(With Regard to a Hardware Configuration)

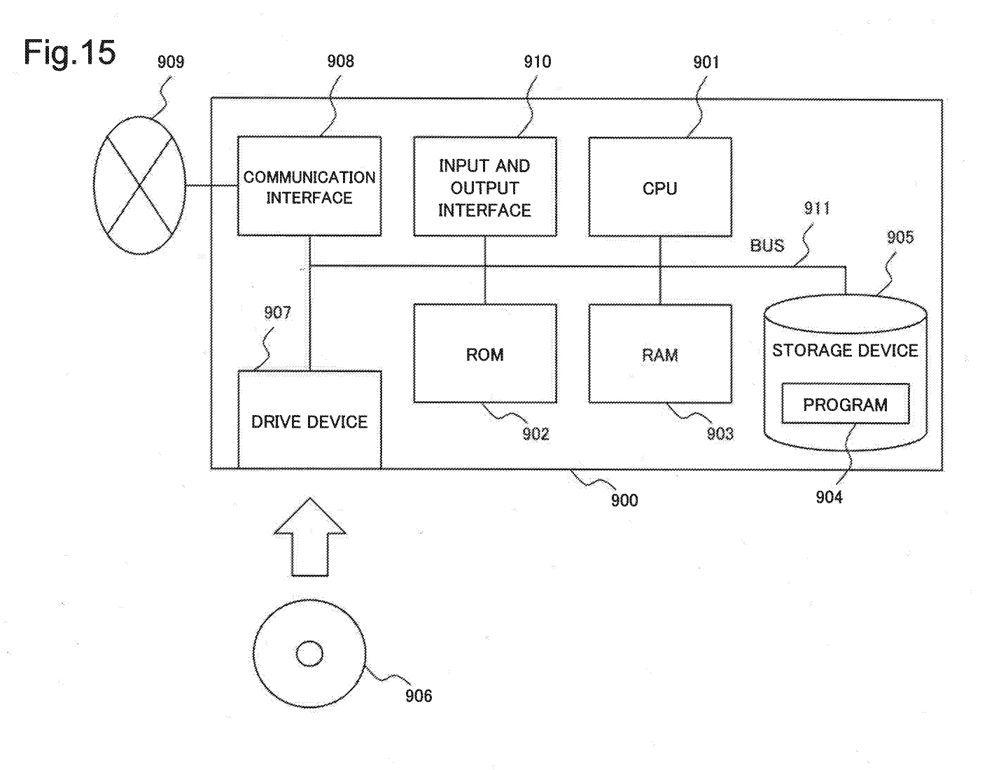

In the example embodiments of the present disclosure, each component of each device indicates a block of a functional unit. A part or all of components of each device are achieved by any combination of an information processing device 900, for example, as illustrated in FIG. 15 and a program. FIG. 15 is a block diagram illustrating one example of a hardware configuration of the information processing device 900 that achieves each of components of each device. The information processing device 900 includes, as one example, the following configuration.
A central processing unit (CPU) 901
A read only memory (ROM) 902
A random access memory (RAM) 903
A program 904 loaded on the RAM 903
A storage device 905 that stores the program 904
A drive device 907 that executes reading from and writing on a recording medium 906
A communication interface 908 for connection to a communication network 909
An input and output interface 910 that inputs and outputs data
A bus 911 that connects components

Each component of each device in the example embodiments is achieved by the CPU 901 acquiring and executing the program 904 that achieves these functions. The program 904 that achieves functions of each component of each device is previously stored, for example, on the storage device 905 or the ROM 902, and is read by the CPU 901, as necessary. Note that the program 904 may be supplied to the CPU 901 via the communication network 909, or may be supplied to the CPU 901 by being previously stored on the recording medium 906 and then read out by using the drive device 907.

A method of achieving each device includes various modified examples. Each device may be achieved, for example, by any combination of the information processing device 900 and a program, separately for each component. Further, a plurality of components included in each device may be achieved by any one combination of the information processing device 900 and a program.

Further, a part or all of components of each device are achieved by another general-purpose or dedicated circuit, a processor, and the like or any combination thereof. These may be configured of a single chip or may be configured of a plurality of chips connected via a bus.

A part or all of components of each device may be achieved by a combination of the circuit described above and a program.

When a part or all of components of each device are achieved by a plurality of information processing devices, circuits, and the like, the plurality of information processing devices, circuits, and the like, may be centralized or distributed. An information processing device, a circuit, and the like, may be achieved as a form, for example, a client-and-server system or a cloud computing system, in which they are connected to each other via a communication network.

Note that the example embodiments described above are preferred example embodiments of the present disclosure and the scope of the present disclosure is not limited to only the example embodiments.

Those of ordinary skill in the art can make modifications or substitutions of the example embodiments and construct a form subjected to various changes, without departing from the gist of the present disclosure.

The whole or part of the exemplary embodiments disclosed above can be described as, but not limited to, the following supplementary notes.

(Supplementary Note 1)

A flow-line classifying device includes:

acquisition means for acquiring, for a plurality of targets, flow-line information representing a path where the target has moved in a certain space and action information that is associated with the flow-line information and represents an action of the target at a position included in the path;

classifying means for classifying the acquired flow-line information, based on the action information associated with the flow-line information; and

outputting means for outputting the flow-line information classified by the classifying means.

(Supplementary Note 2)

The flow-line classifying device according to supplementary note 1, wherein

the action information is specified by executing comparison with a predetermined pattern.

(Supplementary Note 3)

The flow-line classifying device according to supplementary note 2, wherein

the classifying means classifies, based on the specified action information, the flow-line information associated with the action information.

(Supplementary Note 4)

The flow-line classifying device according to supplementary note 2 or 3, wherein

the classifying means classifies, based on a number of times of an action of the predetermined pattern included in the action information, the flow-line information associated with the action information.

(Supplementary Note 5)

The flow-line classifying device according to any one of supplementary notes 2 to 4, wherein the predetermined pattern is different according to the space.

(Supplementary Note 6)

The flow-line classifying device according to any one of supplementary notes 1 to 5, wherein

the classifying means classifies the flow-line information, based on a combination of the action information and a path or a position included in the flow-line information associated with the action information.

(Supplementary Note 7)

The flow-line classifying device according to any one of supplementary notes 1 to 6, wherein

the acquisition means acquires the flow-line information and the action information associated with the flow-line information from a video acquired by an image capture device.

(Supplementary Note 8)

A flow-line classifying method includes:

acquiring, for a plurality of targets, flow-line information representing a path where the target has moved in a certain space and action information that is associated with the flow-line information and represents an action of the target at a position included in the path;

classifying the acquired flow-line information, based on the action information associated with the flow-line information; and

outputting the classified flow-line information.

(Supplementary Note 9)

The flow-line classifying method according to supplementary note 8, wherein

the action information is specified by executing comparison with a predetermined pattern.

(Supplementary Note 10)

A computer-readable non-transitory recording medium recording a program that causes a computer to execute:

an acquisition process of acquiring, for a plurality of targets, flow-line information representing a path where the target has moved in a certain space and action information that is associated with the flow-line information and represents an action of the target at a position included in the path;

a classification process of classifying the acquired flow-line information, based on the action information associated with the flow-line information; and

an output process of outputting the flow-line information classified by the classification processing.

(Supplementary Note 11)

The recording medium according to supplementary note 10, wherein

the action information is specified by executing comparison with a predetermined pattern.

This application is based upon and claims the benefit of priority from Japanese patent application No. 2016-213285, filed on Oct. 31, 2016, the disclosure of which is incorporated herein in its entirety by reference.

### REFERENCE SIGNS LIST

1 Flow-line display system
2 Flow-line display system
10 Flow-line classifying device
11 Acquisition unit
12 Classifying unit
13 Outputting unit
100 Flow-line classifying device
101 Flow-line classifying device
110 Acquisition unit
111 Acquisition unit
120 Classifying unit
130 Outputting unit
140 Pattern generation unit
150 First storage unit
160 Second storage unit
200 Position detection device
300 Action detection device
400 Flow-line-information generation device
500 Display device
600 Image capture device

1. A flow-line classifying device comprising:
a memory; and
at least one processor coupled to the memory,
the processor performing operations, the operations comprising:
acquiring, for a plurality of targets, flow-line information representing a path where the target has moved in a certain space and action information that is associated with the flow-line information and represents an action of the target at a position included in the path;
classifying the acquired flow-line information, based on the action information associated with the flow-line information; and
outputting the flow-line information classified.

2. The flow-line classifying device according to claim 1, wherein
the action information is specified by executing comparison with a predetermined pattern.

3. The flow-line classifying device according to claim 2, wherein
the operations further comprises
classifying, based on the specified action information, the flow-line information associated with the action information.

4. The flow-line classifying device according to claim 2, wherein
the operations further comprises
classifying, based on a number of times of an action of the predetermined pattern included in the action information, the flow-line information associated with the action information.

5. The flow-line classifying device according to claim 2, wherein
the predetermined pattern is different according to the space.

6. The flow-line classifying device according to claim 1, wherein
the operations further comprises
classifying the flow-line information, based on a combination of the action information and a path or a position included in the flow-line information associated with the action information.

7. The flow-line classifying device according to claim 1, wherein
the operations further comprises
acquiring the flow-line information and the action information associated with the flow-line information from a video acquired by an image capture device.

8. A flow-line classifying method comprising:
acquiring, for a plurality of targets, flow-line information representing a path where the target has moved in a certain space and action information that is associated with the flow-line information and represents an action of the target at a position included in the path;
classifying the acquired flow-line information, based on the action information associated with the flow-line information; and
outputting the classified flow-line information.

9. The flow-line classifying method according to claim 8, wherein
the action information is specified by executing comparison with a predetermined pattern.

10. A computer-readable non-transitory recording medium embodying a program, the program causing a computer to perform a method, the method comprising:
acquiring, for a plurality of targets, flow-line information representing a path where the target has moved in a certain space and action information that is associated with the flow-line information and represents an action of the target at a position included in the path;
classifying the acquired flow-line information, based on the action information associated with the flow-line information; and
outputting the flow-line information classified by the classification processing.

11. The recording medium according to claim 10, wherein
the action information is specified by executing comparison with a predetermined pattern.
